(19) United States
(12) Patent Application Publication
(10) Pub. No.: US 2018/0255159 A1
(43) Pub. Date: Sep. 6, 2018

(54) Notification Permission Management

(71) Applicant: Google LLC, Mountain View, CA (US)

(72) Inventors: Joseph Cohen, Los Angeles, CA (US); Justin Lewis, Marina Del Rey, CA (US)

(21) Appl. No.: 15/451,042

(22) Filed: Mar. 6, 2017

(51) Int. Cl. H04L 29/06; H04L 29/08

(52) U.S. Cl. CPC H04L 67/42; H04L 63/10; H04L 67/306; H04L 67/02

(57) ABSTRACT

An example method includes receiving, from an application of a client device, a request, generated based on originating content provided by an originating web server, for target content associated with a target web server. The method also includes identifying a referrer tag in the request that identifies an originating web service associated with the originating web server device or an attribution tag in the request that identifies a trigger event that caused the attribution tag to be included within the originating content. The method additionally includes determining that the referrer tag or the attribution tag is in a set of predefined tags that classifies the originating web service as a notification-like source and, in response, transmitting instructions to the application. Reception of the instructions causes the client device to display a prompt requesting permission to provide notifications from a target web service associated with the target web server device.

### BACKGROUND

A computing device may be configured to execute software applications. The software applications may be connected to the Internet and may thus be configured to provide content from a corresponding web service. When new content becomes available, the software application may provide, by way of a user interface of the computing device, an indication of the new content by way of push notifications. Push notifications, sometimes referred to as server push notifications, provide a mechanism to deliver information to the application without a specific request for that information being provided by the application. The notifications may be delivered when an application is actively being used, when the application is being executed in the background, or when the application is not being executed at all. In order to receive push notifications, a user of the computing device may first need to provide permission to the applications to provide push notifications.

### SUMMARY

Example embodiments are provided herein for managing notification permissions. The notifications may be pushed from a web service to a corresponding software application on a client device. The example embodiments determine contextually-opportune times when a user associated with the client device is likely to provide permission to receive notifications on the client device. Thus, notification permission may be requested by way of the client device at a contextually-opportune time, rather than at a time when the user is less likely to provide permission, such as when the corresponding application is first installed on the client device.

In one example, a method is provided that includes receiving, from an application of a client device by a target web server device, a request for target content associated with the target web server device. The request was generated based on originating content provided by an originating web server device. The reception of the request causes the target web server device to transmit, to the application, data corresponding to the request. The method also includes identifying, by the target web server device, (i) a referrer tag in the request that identifies an originating web service associated with the originating web server device or (ii) an attribution tag in the request that identifies a trigger event that caused the attribution tag to be included within the originating content. The method additionally includes determining, by the target web server device, that the referrer tag or the attribution tag is in a set of predefined tags that classifies the originating web service as a notification-like source. The method further includes, in response to determining that the referrer tag or the attribution tag is in the set of predefined tags, transmitting, by the target web server device, instructions to the application. Reception of the instructions causes the client device to display, on a user interface of the client device, a prompt requesting permission to provide, on the client device, notifications from a target web service associated with the target web server device.

In another example, a non-transitory computer readable storage medium is provided having stored thereon instructions that, when executed by a target web server device, cause the target web server device to perform operations. The operations include receiving, from an application of a client device by the target web server device, a request for target content associated with the target web server device. The request was generated based on originating content provided by an originating web server device. The reception of the request causes the target web server device to transmit, to the application, data corresponding to the request. The operations also include identifying, by the target web server device, (i) a referrer tag in the request that identifies an originating web service associated with the originating web server device or (ii) an attribution tag in the request that identifies a trigger event that caused the attribution tag to be included within the originating content. The operations additionally include determining, by the target web server device, that the referrer tag or the attribution tag is in a set of predefined tags that classifies the originating web service as a notification-like source. The operations further include, in response to determining that the referrer tag or the attribution tag is in the set of predefined tags, transmitting, by the target web server device, instructions to the application. Reception of the instructions causes the client device to display, on a user interface of the client device, a prompt requesting permission to provide, on the client device, notifications from a target web service associated with the target web server device.

In an additional example, a system is provided that includes means for receiving, from an application of a client device, a request for target content associated with a target web server device. The request was generated based on originating content provided by an originating web server device. The reception of the request causes the target web server device to transmit, to the application, data corresponding to the request. The system also includes means for identifying (i) a referrer tag in the request that identifies an originating web service associated with the originating web server device or (ii) an attribution tag in the request that identifies a trigger event that caused the attribution tag to be included within the originating content. The system additionally includes means for determining that the referrer tag or the attribution tag is in a set of predefined tags that classifies the originating web service as a notification-like source. The system further includes means for transmitting instructions to the application in response to determining that the referrer tag or the attribution tag is in the set of predefined tags. Reception of the instructions causes the client device to display, on a user interface of the client device, a prompt requesting permission to provide, on the client device, notifications from a target web service associated with the target web server device.

In a further example, a system is provided that includes a target server device and a tag database communicatively connected to the target server device. The tag database stores a set of predefined attribution tags and referrer tags. The set of predefined tags classifies a web service as a notification-like source. The target web server device is configured to receive, from an application of a client device, a request for target content associated with the target web server device. The request was generated based on originating content provided by an originating web server device. The reception of the request causes the target web server device to transmit, to the application, data corresponding to the request. The target web server device is also configured to identify (i) a referrer tag in the request that identifies an originating web service associated with the originating web server device or (ii) an attribution tag in the request that identifies a trigger event that caused the attribution tag to be included within the originating content. The target web server device is additionally configured to determine, by referencing the tag database, that the referrer tag or the attribution tag is in the set of predefined tags to classify the originating web service as a notification-like source. The target web server device is further configured to transmit instructions to the application in response to determining that the referrer tag or the attribution tag is in the set of predefined tags. Reception of the instructions causes the client device to display, on a user interface of the client device, a prompt requesting permission to provide, on the client device, notifications from a target web service associated with the target web server device.

In yet another example, a method is provided that includes receiving, from an originating application on a computing device, by the computing device, a selection of a link to target content associated with a target application on the computing device. The link is selected from within originating content provided by the originating application. The selection of the link causes an operating system of the computing device to initiate execution of the target application. The method also includes identifying, by the computing device, (i) a referrer tag identifying the originating application or (ii) an attribution tag associated with the link and identifying a trigger event that caused the link to be included within the originating content. The method additionally includes determining, by the computing device, that the referrer tag or the attribution tag is in a set of predefined tags that classifies the originating application as a notification-like source. The method further includes, in response to determining that the referrer tag or the attribution tag is in the set of predefined tags, displaying, on a user interface of the computing device, a prompt requesting permission to provide, on the computing device, notifications from the target application.

In a yet additional example, a non-transitory computer readable medium is provided having stored thereon instructions that, when executed by a computing device, cause the computing device to perform operations. The operations include receiving, from an originating application on the computing device, a selection of a link to target content associated with a target application on the computing device. The link is selected from within originating content provided by the originating application. The selection of the link causes the computing device to initiate execution of the target application. The operations also include identifying, by the computing device, (i) a referrer tag identifying the originating application or (ii) an attribution tag associated with the link and identifying a trigger event that caused the link to be included within the originating content. The operations additionally include determining, by the computing device, that the referrer tag or the attribution tag is in a set of predefined tags that classifies the originating application as a notification-like source. The operations further include, in response to determining that the referrer tag or the attribution tag is in the set of predefined tags, displaying, on a user interface of the computing device, a prompt requesting permission to provide, on the computing device, notifications from the target application.

In a yet further example, a system is provided that includes means for receiving, from an originating application on a computing device, a selection of a link to target content associated with a target application on the computing device. The link is selected from within originating content provided by the originating application. The selection of the link causes the computing device to initiate execution of the target application. The system also includes means for identifying (i) a referrer tag identifying the originating application or (ii) an attribution tag associated with the link and identifying a trigger event that caused the link to be included within the originating content. The system additionally includes means for determining that the referrer tag or the attribution tag is in a set of predefined tags that classifies the originating application as a notification-like source. The system further includes means for, in response to determining that the referrer tag or the attribution tag is in the set of predefined tags, displaying, on a user interface of the computing device, a prompt requesting permission to provide, on the computing device, notifications from the target application.

In yet another additional embodiment, a system is provided that includes a computing device, an operation system on the computing device, a target application on the computing device, and an originating application on the computing device. The operating system is configured to receive, from the originating application, a selection of a link to target content associated with the target application. The link is selected from within originating content provided by the originating application. The selection of the link causes the operating system to initiate execution of the target application. The operating system is also configured to identify (i) a referrer tag identifying the originating application or (ii) an attribution tag associated with the link and identifying a trigger event that caused the link to be included within the originating content. The operating system is additionally configured to determine that the referrer tag or the attribution tag is in a set of predefined tags that classifies the originating application as a notification-like source. The operating system is further configure to, in response to determining that the referrer tag or the attribution tag is in the set of predefined tags, display, on a user interface of the computing device, a prompt requesting permission to provide, on the computing device, notifications from the target application.

These as well as other embodiments, aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a client/server networked environment, according to example embodiments.

FIG. 2 illustrates a schematic drawing of a computing device, according to example embodiments.

FIG. 3 illustrates a flow diagram, according to example embodiments.

FIG. 4A illustrates a notification-like context, according to example embodiments.

FIG. 4B illustrates another notification-like context, according to example embodiments.

FIG. 5 illustrates a message diagram, according to example embodiments.

FIG. 6 illustrates another message diagram, according to example embodiments.

FIG. 7 illustrates a graphical user interface, according to example embodiments.

FIG. 8 illustrates example contextual indicators, according to example embodiments.

FIG. 9 illustrates another flow diagram, according to example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless indicated as such. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For purpose of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Overview

Push notifications involve a web server sending, or “pushing,” information to a client device to indicate, to a user of the client device, an event or status change in a website or web service hosted by or associated with the web server. The event or status change may be availability of new content or a communication received through the web service, among other possibilities. In contrast, a pull notification, or polling, involves a client device requesting that a server check if there are any events or status updates of which the client devices has not yet been notified. Push notifications generally experience a smaller delay between content becoming available on the web server and a client computing device displaying a notification of the new content.

However, since push notifications are provided without the client device requesting the notification, the notifications may, in some circumstances, become undesirable to a user of the computing device. In one example, a user may find that notifications pushed by a particular web service are too frequent or that the content of the notifications is not of interest to the user, among other possibilities. Accordingly, the user may choose to disable future notifications from the web service. However, disabling notifications may reduce the extent of the user's interaction with the web service or software application associated therewith that is now unable to push notifications to the user. Further, the reduced interaction with software applications may result in reduced interaction with the computing device as a whole.

Additionally, many computing devices provide a simplified process of disabling notifications, making it easier to disable than to enable notifications. For example, notifications from a particular web service may be disabled by performing a predefined user interface gesture (e.g., by pressing and holding for at least a threshold amount of time a notification from the particular web service). In contrast, a corresponding simplified process is not available for re-enabling notifications, which often involves numerous steps that the user might not be aware of or might not want to go perform.

For example, many operating systems currently only permit an application to prompt the user for permission to display operating system-level notifications once. This prevents applications from overloading a user with undesired notifications. However, if the user declines to receive these notifications, there might not be a way for the application to ask for permissions a second time. To re-enable permissions, the user might need to go through several layers of operating-system-level application settings to manually provide notification permission to a particular application or web service. Again, some users might not be aware of such settings or how to modify them. This presents a problem for applications that rely on notifications to inform users of events and maintain user engagement by way of such notifications.

Further, in some instances, web services might only be allowed to request permission to provide notifications at predetermined times, when users are unlikely to provide an affirmative response. In one example, applications might be allowed to prompt for permissions to display operating system-level notifications at the time of installation, before the user has had an opportunity to engage with the application. Accordingly, many users may, by default, not grant permission to display notifications because they are not familiar with the application. This shortcoming is not limited to operating system-level notifications. Notably, some applications might also set a cap on the maximum number of times that a particular web service is permitted to prompt a user for permission to display application-level notifications from the particular web service.

In one example, a web browser may maintain a set of permissions for each web domain accessed using the web browser. Similarly, each web domain might be allowed to prompt for permissions to provide notifications only once when the user first accesses content from the web domain (i.e., prior to engaging with the content). Thus, the user is likely to be prompted for permissions to receive notifications at a time when the user is unlikely to provide authorization. Further, the limited number of permission prompts may hinder the web service's ability to prompt the user at a more opportune time when the user is likely to authorize notifications.

Accordingly, described herein are operations for managing notification permissions. In particular, the operations are directed at determining, based on a context in which the user is engaging with a web service, whether to prompt the user to receive notifications from the web service. The context in which the user is engaging with the web service may be used to determine whether a user, if prompted for permissions to receive notifications, is likely to respond in the affirmative. If the context indicates that the user is likely to provide permission to receive notifications from the web service, the web service may prompt the user for permission.

The operations herein allow a web service, an application, or an operating system to request permission to display push notifications at contextually-opportune times. That is, the operations balance (i) the need to limit the frequency with which notifications are provided on a computing device against (ii) the need to allow web services to re-prompt for permission to provide notifications to maintain user engagement. For example, through the operations herein disclosed, an operating system may allow an application to prompt for notification permission more than once without risking the application overloading the user with permission requests. This balance is achieved by using attribution tags and referrer tags to identify times (i.e., contexts) when a user likely desires to receive notifications and is thus likely to provide permission. The user is prompted for permission to be provided with notifications at the identified times.

The operations herein may be implemented at any level of a software platform of a computing device. In particular, the operations may be implemented as part of an operating system, an application, an Application Programming Interface (API), layers thereof, or layers therebetween. Further, the operations may be distributed between two or more computing devices, such as a client device and a server device. The operations may be used by an application to control application-level notifications, by an application to control operating system-level notifications, by an operating system to control operating system-level notifications, or by an operating system to control application-level notifications.

Accordingly, throughout this description, unless context indicates otherwise, the terms “notification” or “push notification” may refer to operating system-level notifications, application-level notifications, or any other level of notifications that may be provided to and displayed by a computing device. Further, the terms “web service,” “website,” and “web server” are used interchangeably. Each web service may be associated with at least one corresponding web server device configured to host and serve contents of the web server to client devices.

The server and client devices may be configured to communicate using various Internet protocols and standards, including the Transmission Control Protocol (TCP), Internet Protocol (IP), Hypertext Transfer Protocol (HTTP), Hypertext Markup Language (HTML), and eXtensible Markup Language (XML), among other options. Content of each website may be accessible by way of a web browser of the client device. However, the content may also be accessible using a corresponding “native” software application configured to be executed by a specific operating system or software platform of the computing device.

As noted above, the context in which a user is engaging with a web service may be determined based on an attribution tag or a referrer tag. The web service may be referred to as a target web service. The attribution tag may be a token (e.g., a Universal Resource Identifier parameter) included in a link selected by the user to access content offered by the target web service. The link may be included within the content of an originating web service (i.e., a web service from which the user was linked to the target web service). The originating web service may be identified by the referrer tag.

After the attribution tag is generated to be included within the link, the attribution tag may be stored in a database and may be used to identify a trigger event that caused the attribution tag to be generated and included in the link. Example trigger events may include the target web service sending an email to the user, or another user associated with the target web service posting the link to another web service (i.e., including the link within the web content of the another web service).

The attribution and referrer tags may be used to determine whether the user was informed of the content on the target web server through an event or series of events that are functionally similar or equivalent to a push notification. Specifically, the attribution tag may be referenced against an attribution tag database to determine whether the attribution tag was generated in response to a notification-like event. Similarly, the referrer tag may be referenced against a database of predefined referrer tags to determine whether the referrer tag identifies a notification-like source. If the user is accessing the content of the target web service from a notification-like context or source, it is likely that the user will respond positively to a request to provide permission to receive notifications from the target web service. Thus, the user may be prompted for such permission around the time the user has accessed the link from the notification like context.

### II. Example Client Devices and Systems

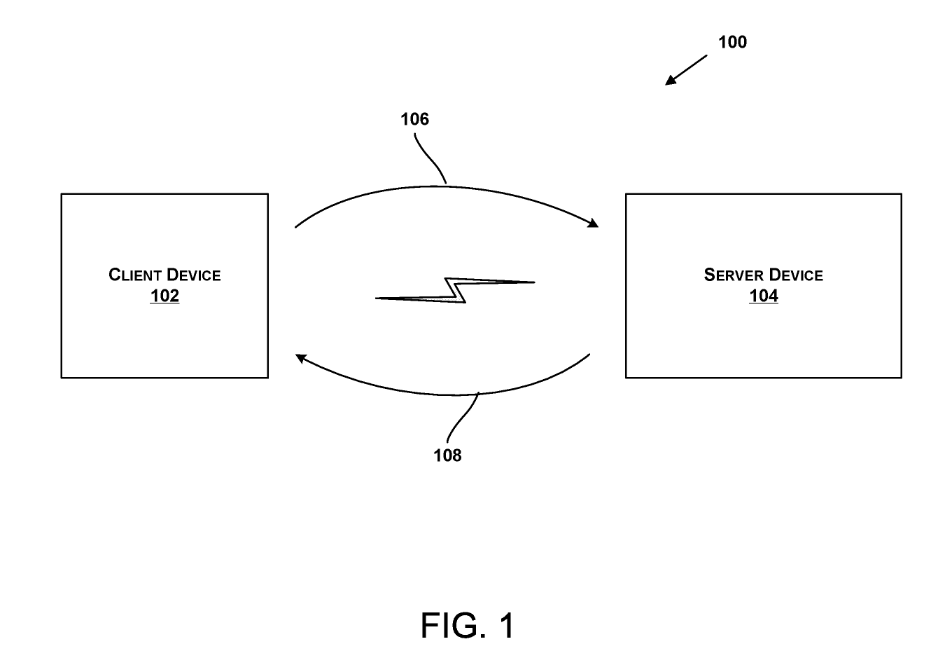

FIG. 1 illustrates an example communication system 100 for carrying out one or more of the embodiments described herein. Communication system 100 may include computing devices. Herein, a “computing device” may refer to either a client device (e.g., a wireless computing device or a wired computing device), a server device (e.g., a networked cluster of server equipment), or some other type of computational platform.

Client device 102 may be any type of device including a laptop computer, a wearable computing device, a wireless computing device, a head-mountable computing device, a mobile telephone, or tablet computing device, etc., that is configured to transmit data 106 to and/or receive data 108 from a server device 104 in accordance with the embodiments described herein. For example, in FIG. 1, client device 102 may communicate with server device 104 via one or more wireless interfaces. In some cases, client device 102 and server device 104 may communicate with one another via a local-area network. Alternatively, client device 102 and server device 104 may each reside within a different network, and may communicate via a wide-area network, such as the Internet.

Client device 102 may include a user interface, a communication interface, a main processor, and data storage (e.g., memory). The data storage may contain instructions executable by the main processor for carrying out one or more operations relating to the data sent to, or received from, server device 104. The user interface of client device 102 may include buttons, a touchscreen, a microphone, and/or any other elements for receiving inputs, as well as a speaker, one or more displays, and/or any other elements for communicating outputs.

Server device 104 may be any entity or computing device arranged to carry out server operations. Further, server device 104 may be configured to send data 108 to and/or receive data 106 from the client device 102.

Data 106 and data 108 may take various forms. For example, data 106 and 108 may represent data packets transmitted by client device 102 or server device 104 as part of a communication session. Such a communication session may include data packets transmitted on a signaling plane (e.g., session setup, management, and teardown messages), and/or data packets transmitted on a media plane (e.g., audio data).

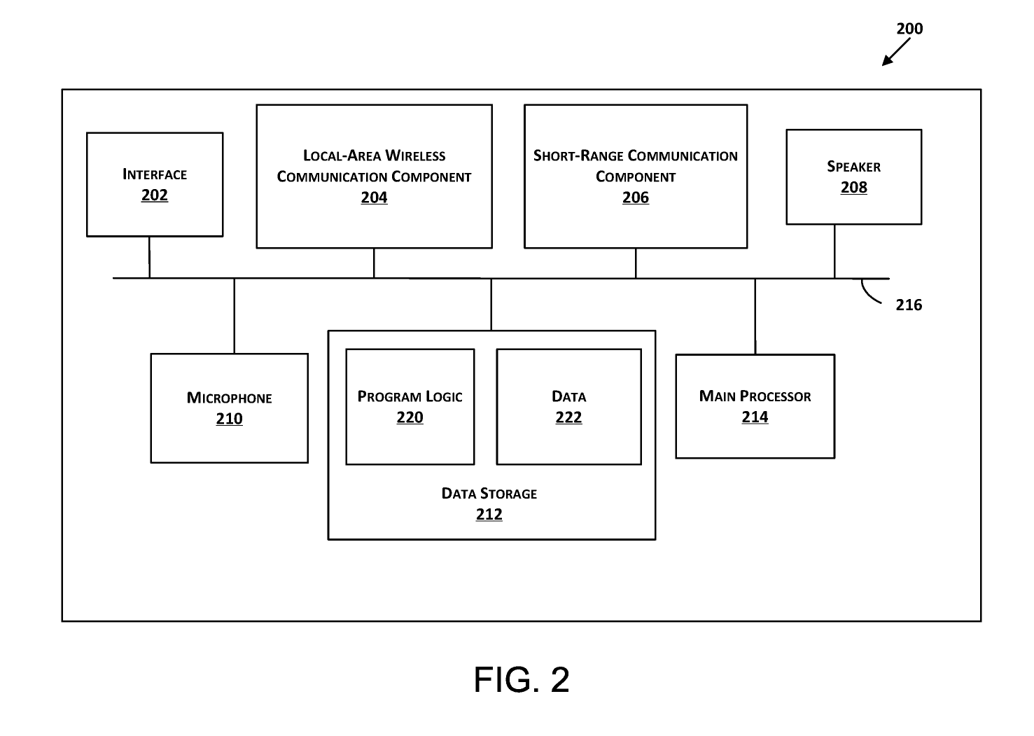

FIG. 2 illustrates a schematic drawing of an example computing device 200, where computing device 200 is an example embodiment of client device 102. Thus, computing device 200 may, for example, take the form of any client device described above in relation to FIG. 1. In some examples, components illustrated in FIG. 2 may be distributed across multiple client devices. Nonetheless, for illustrative purposes, components are shown and described in FIG. 2 as part of an example computing device 200.

In some implementations, computing device 200 may include a device platform or operating system (not shown). The device platform may include different applications and an application framework, as well as various kernels, schedulers, memory managers, libraries, and runtime entities. In some examples, other software modules may operate on computing device 200 as well.

Computing device 200 may include an interface 202, a local area wireless communication component 204, a short-range communication component 206, a speaker 208, a microphone 210, data storage 212, and a main processor 214. Components illustrated in FIG. 2 may be linked together by a communication bus 216. computing device 200 may also include additional hardware to enable further functionality and/or operations.

Interface 202 may be configured to allow a user to interact with computing device 200. Thus, interface 202 may include user-interface components, such as a keyboard, touchscreen, touchpad, presence-sensitive input device, display, etc.

Local-area wireless communication component 204 may be a communication interface that is configured to facilitate wireless data communication according to one or more wireless communication standards or non-standard protocols. For example, local-area wireless communication component 204 may include a Wifi interface that is configured to facilitate wireless data communication according to one or 802.11 protocols. Other examples are possible.

Short range communication component 206 may be a communication interface that is configured to facilitate wireless data and/or voice communication according to one or more personal-area wireless communication standards or non-standard protocols. For example, short range communication component 206 may be configured to facilitate wireless data communication according to one or more Bluetooth protocols. Other examples are possible.

Speaker 208 may be any type of apparatus that can produce sound. In some cases, speaker 208 may convert digital representations of sounds (e.g., digitally encoded voice or music signals) into audible analog representations of the sounds. Speaker 208 may be integrated with computing device 200, or may exist as a removable module (e.g., headphones or an external speaker).

Microphone 210 may be any type of apparatus that can receive analog sound. In some cases, microphone 210 may convert analog representations of sounds into digital representations of these sounds. Like speaker 208, microphone 210 may exist as a removable module (e.g., an external microphone).

Data storage 212 may store program logic 220 that can be accessed and executed by main processor 214. Program logic 220 may include machine-readable instructions that, when executed by main processor 214, cause computing device 200 to carry out various operations and procedures. Data storage 212 may also store data 222 that may include data collected by any of interface 202, local-area wireless communication component 204, short range communication component 206, and/or microphone 210. Data storage 212 may store additional data as well. Data storage 212 may be a non-transitory computer-readable data medium, such as a hardware memory module.

Main processor 214 may be any type of one or more microprocessors or general-purpose processors. However, main processor 214 may be integrated with or include various types of co-processors, network processors, graphics processors, and/or digital logic. Main processor 214 may support multiple power modes, including a low-power mode and a high-power mode. Main processor 214 may use less power when in the low-power mode than when in the high-power mode.

Communication bus 216 is illustrated as a wired connection; however, wireless connections may also be used. For example, communication bus 216 may be a wired serial bus, such as a universal serial bus (USB), or a parallel bus. Alternatively or additionally, communication bus 216 may be a wireless connection using, e.g., short-range wireless radio technology, communication protocols described in IEEE 802.11 (including any IEEE 802.11 revisions), or cellular technology, among other possibilities.

### III. Example Operations

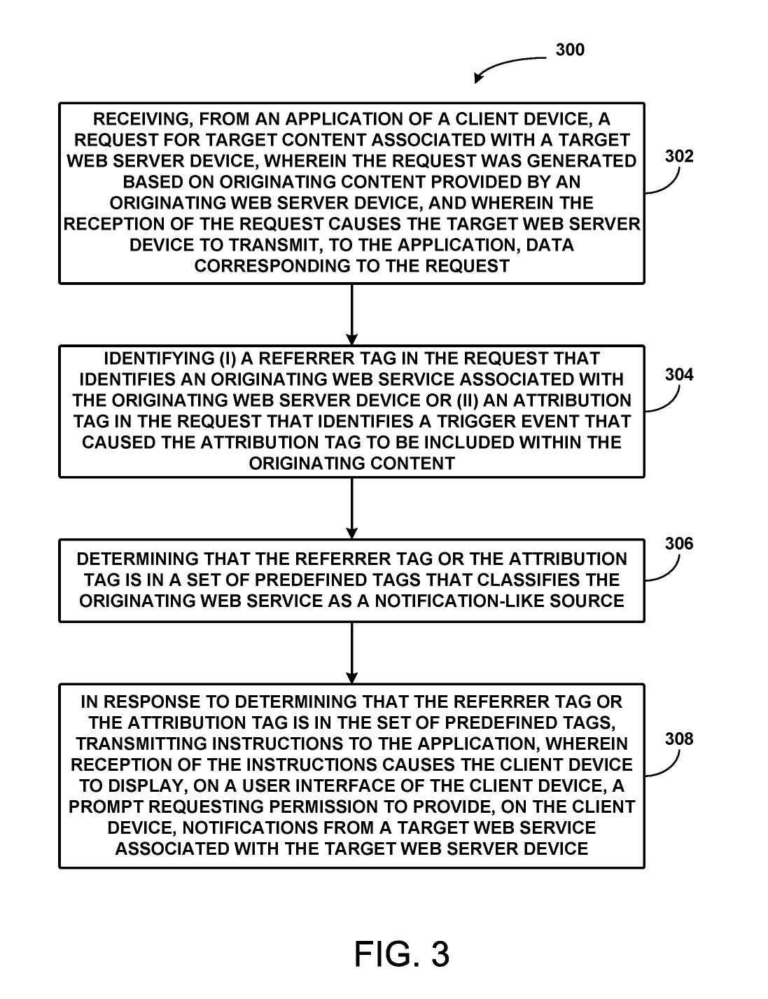

FIG. 3 is a flow chart 300 illustrating example operations. The embodiment illustrated by FIG. 3 may be carried out by a computing device, such as computing device 200. However, the embodiment can also be carried out by other types of devices or device subsystems. For example, the embodiment may be carried out by a server device (e.g., the target web server device) communicatively connected to computing device 200 from which computing device 200 may request web content. Further, the embodiment may be combined, in part or in whole, and may incorporate any aspect or feature disclosed in this specification or the accompanying drawings.

In block 302, a target web server device may receive, from an application of a client device, a request for target content associated with the target web server device. The request may have been generated based on originating content provided by an originating web server device. The reception of the request may cause the target web server device to transmit, to the application, data corresponding to the request

The request for the target content may be generated by the client device in response to selection of a link to the target content. The selection of the link may be received from a user of the client device by way of the application of the client device. The link may be selected from within the originating content displayed using the application.

A link (e.g., hyperlink) may be a reference or address to data or content (e.g., text or graphics) stored on a computing device (e.g., a web server device). In some instances, the computing device may be communicatively connected to the Internet and the content may thus be remotely accessible by other computing devices. The selection of the link may involve a user clicking, pressing, tapping, or otherwise providing a gesture recognized by the client device to select the link.

In some embodiments, the originating web server device may be associated with an originating web service. For example, the originating web server may host a first website and may, in response to requests from client devices, provide data representing content of the first website. Likewise, the target web server may be associated with a target web service. For example, the target web server may host a second website. Thus, selection of the link may include clicking a link on the first website that addresses content on the second website.

In some instances, the client device may include an originating application configured for displaying and interacting with the originating content of the originating web service and a target application configured for displaying and interacting with the target content of the target web service. An operating system or API of the client device may be configured to provide for deep linking to content within these applications. Deep linking may include requesting the content addressed by a link and instantiating a user interface within the application to display the addressed content, rather than instantiating the application to a general/default user interface screen. That is, in response to selection of the link within the originating application, the target application may be launched and executed to display, in a corresponding user interface instance of the target application, the deep-linked target content addressed by the link. Alternatively, the client device may rely on a single application, such as a web browser, to provide for display and interaction with the originating and target web services.

In block 304, the target web server device may identify (i) a referrer tag in the request that identifies an originating web service associated with the originating web server device or (ii) an attribution tag in the request that identifies a trigger event that caused the attribution tag to be included within the originating content.

In general, the referrer tag may identify a website or web service that linked to content of a subsequent website or web service (i.e., identify the website or web service visited by the user immediately prior to arriving at the subsequent website). Thus, the referrer tag may be any data that identifies the originating web service or the originating web server. In some embodiments, the referrer may be an HTTP referrer (sometimes spelled “referer”), stored in an HTTP request header field, that identifies the address of the web page (i.e., the Uniform Resource Identifier (URI) or International Resource Identifier (IRI)) that linked to the target web service.

The referrer tag may be determined, in response to selection of the link, by the application or operating system of the client device and may be included thereby in the request provided to the target web server device. In some examples, the referrer may include a complete deep-link to the content from within which the link was selected (e.g., the full address of the originating/source website, including any domains, subdomains, and paths addressing the content: www.examplewebservice.com/all_content/sub_content/specific_instance of content). Alternatively, the referrer might only include the domain or subdomain associated with the originating web server device (e.g., www.examplewebservice.com).

In one example, the web browser on the client device may include, in the request sent to the target web server device, the URI of the originating content provided by the originating web server device. In another example, the operating system may determine the referrer tag by including, within the request to the target server device, an identifier of the originating application used to display the originating content provided by the originating web server device. The identifier may include a name of the application, a URI, a domain, or a subdomain of the deep-linked content of the originating application from within which the link was selected. Thus, identifying the referrer tag may involve the target web server device parsing the request received from the client device to identify, within the request, a parameter representing the referrer tag.

The attribution tag in the request may be a parameter or token included within the link (e.g., the URI). The attribution tag may be a part of the link itself so as to remain intact within the link as the link is shared by, for example, being copied from one web service and pasted to another web service. The attribution tag may be encoded within the link according to a set standard. For example, the attribution tag may be a Common Gateway Interface (CGI) parameter embedded within the link. An example link including an attribution tag represented by a CGI parameter might read “http://example.com/?attribution_tag=tag_value_1,” where “attribution_tag” represents the attribution tag parameter and “tag_value_1” represents the value of the attribution tag parameter.

The attribution tag may be used to identifying a trigger event that caused the link to be generated or included within the originating content provided by the originating web server device. That is, the attribution tag may identify an event to which inclusion of the link in the originating content is attributed. Each generated attribution tag may be stored in a database along with a corresponding descriptor that identifies the trigger event.

An example trigger event includes the link being generated by the target web service and included in a communication sent from the target web service to the user associated with the client device by way of the originating web service. For example, a video sharing service may send an email to the user informing the user of new video content available from the video sharing service. The email may include a link, embedded with the attribution tag, to the new video content.

Another example trigger event includes the link being generated by the target web service and included in content of the originating web service by another user associated with the target web service or the originating web service. For example, a first user of the video sharing service may click a “share” button to post a video from the video sharing service to a separate social media service. When the “share” button is clicked, the generated link may be embedded with an attribution tag identifying that the link was originally shared by the first user. Thus, when a second user sees and clicks the link on the social media service, the video sharing service will be able to identify that the link was originally shared by the first user.

Accordingly, in block 306, the target web server may determine that the referrer tag or the attribution tag is in a set of predefined tags that classifies the originating web service as a notification-like source. The set of predefined tags may, in some examples, be stored in a database associated with the target web server device. Thus, the originating web service may be classified as a notification-like source when there is a match between the set of predefined tags and at least one of the attribution tag or the referrer tag.

Classifying the originating web service as a notification-like source amounts to determining that the user has selected the link from a notification-like context or in response to a notification-like event. A source, context, service, or event may be classified as notification-like when it provides information regarding content or events associated with the target web service. In particular, the source, context, service, or event may be regarded as notification-like where it is functionally similar or equivalent to a push notification and where the provided information or an indication thereof might otherwise be included in a push notification from the target web service. For example, the video sharing service emailing a link to the user may be classified as a notification-like event because the email is an indirect notification of new content available from the video sharing service.

Thus, the referrer tag or the attribution tag may be used to determine that the user is accessing content of the target web service in response to what is essentially a notification provided to the user indirectly by way of the originating content of the originating web service. Accordingly, the user would likely find desirable a notification on the client device, provided directly from the target web service, informing the user of the content or event on the target web service. The context may be used to determine whether the user, if prompted for permission to receive notifications on the client device from the target web service, is likely to respond in the affirmative. That is, the context may be used to identify an opportune time at which to prompt the user for permission to provide notifications on the client device from the target web service.

Accordingly, in block 308, the target web server device may, in response to determining that the referrer tag or the attribution tag is in the set of predefined tags, transmit instructions to the application. Reception of the instructions may cause the client device to display, on a user interface of the client device, a prompt (e.g., a dialog prompt) requesting permission to provide, on the client device, notifications from a target web service associated with the target web server device.

Thus, rather than prompting for notification permission at predetermined times (e.g., at the time of application installation, when the user first accesses a particular web service, etc.), the client device may instead prompt at the determined opportune time. That is, the user may be prompted at a time when the user is likely to provide authorization to receive, via the client device, notifications (e.g., push notifications) from the target web server device. Accordingly, the operations of flow diagram 300 may allow web services to avoid prompting for notification permissions at contextually-inopportune times, when the user is unlikely to provide permissions and might instead block notifications altogether.

Although the operations of flow diagram 300 are described as being performed by the target web server device, in some instances, the operations may be performed by an operating system of computing device 200, an API of computing device 200, an application on computing device 200, or a combination thereof. Further, the operations of flow diagram 300 may also be distributed between computing device 200 and the target web server device.

### IV. Example Notification-Like Contexts Indicated by Tags

Attribution tags and referrer tags may be used separately or in combination to identify the context in which content addressed by a link associated with the tags is accessed. In particular, the tags may be used to determine that a user of a client device is accessing content of a target web service in response to a notification-like event or series of events. The notification-like event may be an indication of content available from a target web service, where the indication, rather than being provided to a user directly, through a notification (e.g., push notification), is provided instead by way of an originating web service other than the target web service.

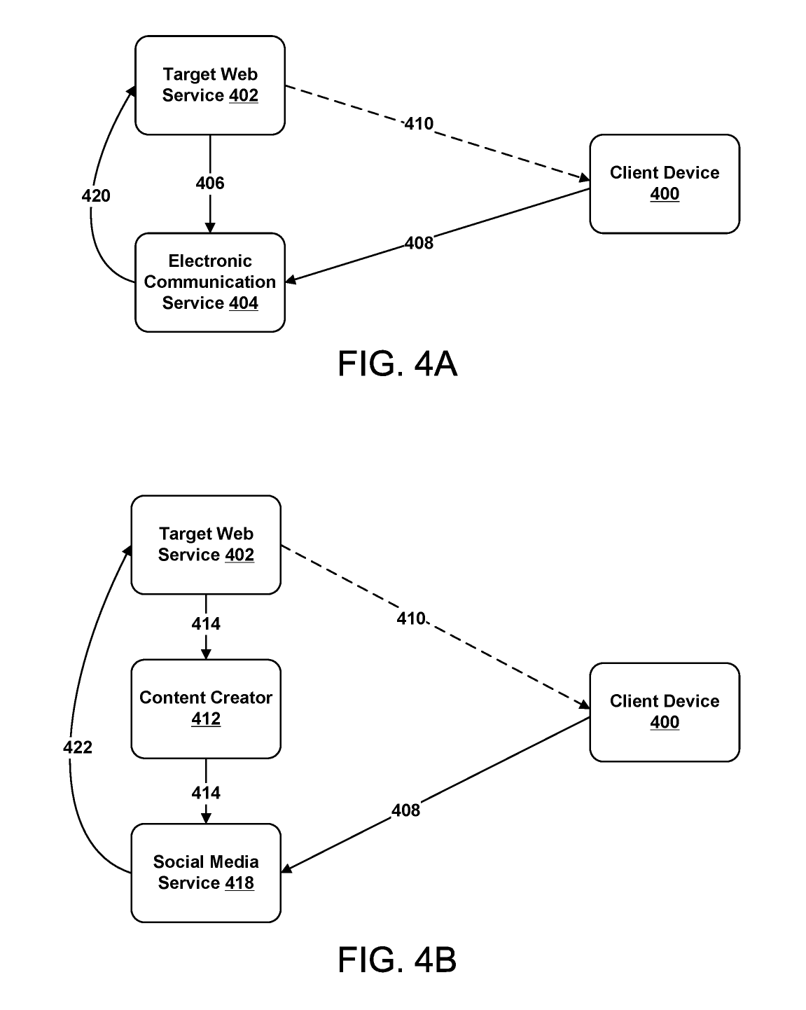

FIGS. 4A and 4B illustrate examples of notification-like contexts. In particular, FIG. 4A illustrates target web service 402, electronic communication service 404, and client device 400. Target web service 402 may be any collection of accessible content, dynamic or static, addressable by a URI (e.g., a website). Target web service 402 may be associated with a target web server device configured to host target web service 402 and serve data in response to requests therefor. For example, target web service 402 may be a video sharing platform through which users may share and view video content. Electronic communication service 404 may be a website or web service configured to facilitate the exchange of electronic communications between computing devices connected to the Internet (e.g., email service, messaging service, group chat, etc.). Client device 400 may be any computing device configured to communicate with at least target web service 402 and electronic communication service 404 (e.g., computing device 200). Client device 400 may be associated with a user and may store thereon user-specific data (e.g., content, settings, preferences, etc.).

Target web service 402 may be capable of providing notifications to client device 400 directly, as indicated by arrow 410. However, target web service 402 might not have permission to push notifications to client device 400 directly, as indicated by the dashed pattern of arrow 410. In particular, target web service 402 might not yet have requested permission to display notifications or might have requested permission and received a negative response. Rather than repeatedly prompt or re-prompt for permissions, which may annoy the user or, in some instances, might not be permitted, target web service 402 may rely on the operations herein disclosed to determine, based on context, when to prompt or re-prompt for permission.

In one example, illustrated in FIG. 4A, target web service 402 may itself create a notification-like context. In particular, target web service 402 may send to the user associated with client device 400 an email or other electronic message containing therein a link to content offered by target web service 402. The email may be sent to the user by way of electronic communication service 404, as indicated by arrow 406. The user may access the email by visiting a website or accessing an application associated with electronic communication service 404 (e.g., an email application), as illustrated by arrow 408. In response to selecting the link, the user may be taken to the content on target web service 402 addressed by the link, as shown by arrow 420.

The link may include therein an attribution tag. Prior to sending the email with the link, target web service 402 may generate the attribution tag, along with a corresponding descriptor, and may insert the tag into the link (i.e., may generate a link that includes the generated attribution tag). The descriptor may indicate that the link containing the particular attribution tag was sent via electronic communication service 404 to the user by the target web service 402. The attribution tag, the descriptor, as well as any other contextual data (e.g., date, time, ID of the user to which the link was sent, identifier of the electronic communication service 404, etc.) may be stored in a database associated with target web service 402.

Thus, when the user selects the link at a later time, target web service 402 will be able to identify, based on the attribution tag in the link, that the link was sent to the user by the target web service 402 via email. Further, in some instances, target web service 402 may also determine, based on the referrer tag, that the link was selected from within content provided by electronic communication service 404, rather than other web content.

Selecting the link from within the email sent by target web service 402 may be classified as a notification-like context because, by sending the email to the user, target web service 402 is essentially providing an indirect notification to the user of content available from target web service 402. If the user responds to this email by clicking the link, this indicates that the user is likely interested in content from target web service 402. Further, since the user just engaged with a notification-like communication, it is also likely that the user, if prompted for permission to receive, on client device 400, notifications from target web service 402, will respond in the affirmative.

Accordingly, the user may be prompted to enable notifications from target web service 402 when the context indicates that the user is likely to provide permission. For example, target web service 402 may, in response to determining that client device has accessed content in a notification-like context, provide instructions to client device 400 to cause client device 400 to display a prompt requesting, from a user of client device 400, permission to provide notifications on client device 400 from target web service 402.

In another example, illustrated in FIG. 4B, another user associated with target web service 402 may create a notification-like context. In particular, FIG. 4B illustrates target web service 402, content creator 412, social media service 418, and client device 400. In one example, content creator 412 may be an author or producer of content available through target web service 402 or social media service 412. For example, content creator 412 may be a user that posted a video, photo, or written work on target web service 402 or social media service 418. Social media service 418 may be a website or web service that includes user-generated content and facilitates communication between members of the service.

Content creator 412 may share, via social media service 418, a link to content of target web service 402, as indicated by arrows 414. The content which the link addressed may be, for example, content created by content creator 412 (e.g., a video recorded and uploaded to target web service 402 by content creator 412). Alternatively, the content which the link addresses may be content that content creator 412 did not create, but is nevertheless sharing by way of social media service 418. In response to selecting the link, a user associated with computing device 400 may be taken to the content of target web service 402 addressed by the link, as shown by arrow 422.

The link may include therein an attribution tag. Target web service 402 may generate the attribution tag, along with a corresponding descriptor, and may insert the tag into the link (i.e., may generate a link that includes the generated attribution tag). The generated attribution tag may be automatically included within the link when content creator 412 is sharing the link. For example, when content creator 412 copies the link from an address bar of a web browser, the link might already include the generated tag. That is, any time content is provided from target web service 402 to content creator 412, the corresponding URI address may include an attribution tag. Alternatively, when content creator 412 clicks a “share” button to automatically post the link to social media service 418, the generated link may include the attribution tag. Thus, links shared by content creator 412 may be identifiable due to the included attribution tags.

The descriptor corresponding to the attribution tag included in links shared by content creator 412 may indicate that the link containing the attribution tag was originally shared by content creator 412. That is, the trigger event that caused the attribution tag to be generated and the link to be included within the content of social media service 418 is content creator 412 sharing the link. The attribution tag, the descriptor, as well as any other contextual data (e.g., date, time, ID of content creator 412, etc.) may be stored in a database associated with target web service 402.

Thus, when the user selects the link at a later time, target web service 402 will be able to identify, based on the attribution tag in the link, that the link was originally shared by content creator 412. Further, in some instances, target web service 402 may also determine, based on the referrer tag, that the link was selected from within content provided by social media service 418.

The referrer tag may provide a separate signal that may be used individually or in combination with the attribution tag to identify notification-like contexts. As previously discussed, the referrer tag identifies the website, web service, or application from which a link to content of the target web service 402 was selected (i.e., the originating web service). The referrer may be referenced against a referrer tag database including a predetermined set of websites classified as notification-like to determine whether the referrer is within the set. Websites may be classified as notification-like if they are configured to inform viewers of content available from other websites. Examples of notification-like websites include social networking websites, professional networking websites, email services, chat services, and news services.

In some embodiments, the classification of a website as notification-like may be a binary yes/no classification. In other instances, each respective website may be associated with a score based on, for example, how frequently the respective website links to content of the target web service 402. Thus, a website may be classified as a notification-like website if the score exceeds a threshold value.

In some instances, the referrer alone may be sufficient to identify a notification-like context. For example, a user may link to target web service 402 from an originating web service configured to provide notification-like information of content available from other web services such as, for example, an email service or a social media service. The event of the user arriving at content of target web service 402 from an email service may sufficiently signal that the user is responding to a notification-like event, regardless of how that email was originally sent to the user.

However, using the attribution tag and the referrer tag in combination may allow for more accurate and reliable indications of context. For example, a user arriving at content of target web service 402 from an email sent to the user by target web service 402 may be a stronger indicator of notification-like context than the user arriving at the content from an email without a known origin. Likewise, a user arriving at content of target web service 402 from social media service 418 via a link shared by content creator 412 may indicate that the user is following content creator 412 via social media service 418 for regular content updates. This may be a stronger indicator than the user following the link shared by content creator 412 from an originating web service that is not classified as notification-like.

Accordingly, accessing a link to content of target web service 402 from social media service 418 may indicate a notification-like context because, by posting a link to the social media service 418, content creator 412 is essentially providing a notification to users/members of social media service 418 of content available on target web service 402.

In some instances, block 412 may instead represent a member of target web service 402 or social media service 418. In particular, member 412 may be part of a social network to which the user associated with client device 400 belongs. Thus, links shared by member 412 and accessed by the use of client device 400 may also signal a notification-like context.

In some embodiments, a “strength” of the notification-like context may be indicated with a score. For example, the score may be an estimated probability of a user responding to a request to enable notifications in the affirmative. The probability may be determined based on the referrer and attribution tags as well as the data stored in association therewith. Additionally, in some instances, the notification-like context score may be based on (e.g., inversely proportional to) an amount of time elapsed between when the link was first generated to be shared and when content addressed by the link was accessed. Further, the notification-like context score may be based on (e.g., proportional to) a frequency with which content of target web service 402 is accessed by client device 400.

Additionally, in some embodiments, a web service may provide different tiers of notifications. A first tier may include a digest notification informing a user of only a select subset of new content and events on a web service. The first notifications tier may provide notifications with a first frequency. A second tier may include individual notification for each event associated with the web service or a subsection of the web service. For example, as a result of subscribing to the second tier of notifications, a user may be notified every time a content creator associated with a web service uploads new content to the web service. The second notifications tier may provide notifications with a second frequency. The second frequency may generally be higher than the first frequency.

Further, in some instances, notifications may be based on the type of content that a user has accessed by selecting the link. For example, a web service may provide notifications of new products (i.e., content of a first type) and sales (i.e., content of a second type). A particular user may be particularly receptive to all communications concerning new products but might show little to no interests in communications concerning sales. Accordingly, the user may be prompted to enable notifications concerning new products but not sales.

### V. Example Server-Based Implementation Control Flow

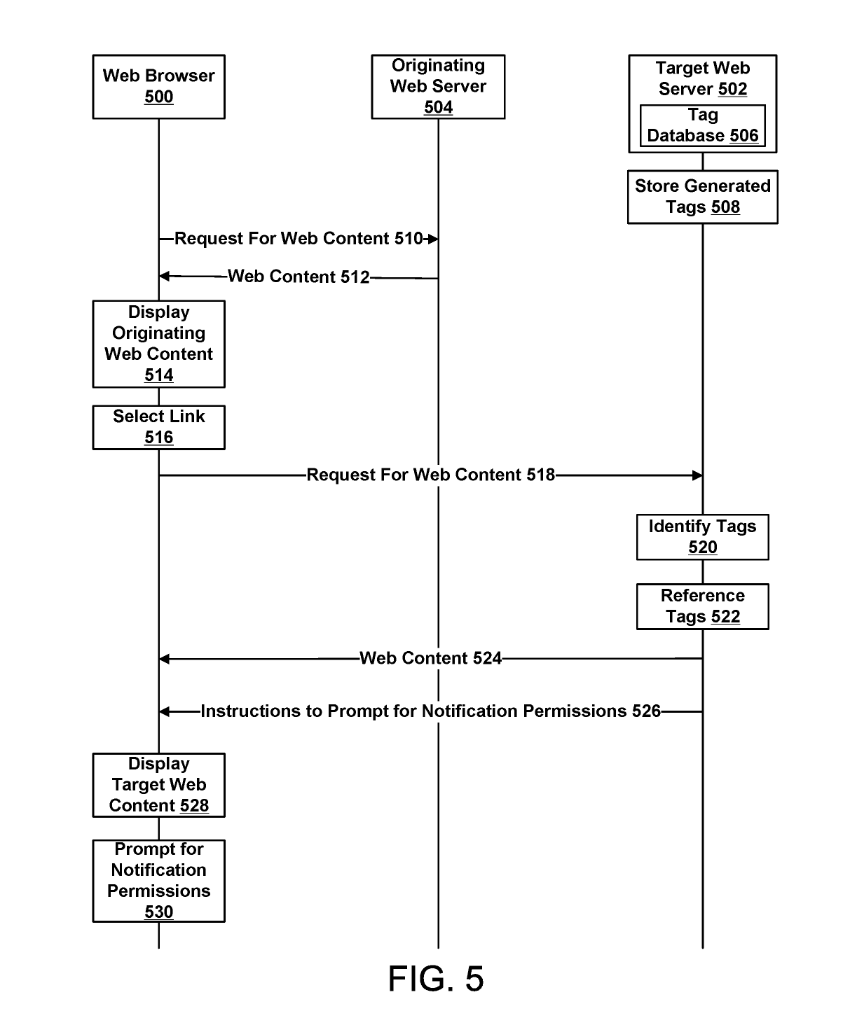

FIG. 5 includes an example message diagram illustrating operations that may be carried out to determine when to prompt, by a web browser on a computing device, for permission to display notifications from a target web service. The notifications may be browser-level notification (i.e., application-level notifications since a browser may be considered an application) provided by the web browser or they may be system-level notifications provided by an operating system of the computing device by which the browser is being executed. The operations illustrated in FIG. 5 may be carried out before prompting for permission for a first time or after a previous prompt for permission resulted in permission not being granted.

In particular, web browser 500 may be used to access content provided by an originating web service hosted on originating web server 504. Web browser 500 may also be used to access content provided by a target web service hosted on target web server 502. Web browser 500 may be executed by a computing device associated with a user (e.g., client device 102 illustrated in FIG. 1). Web browser 500 may access the content of the originating web service by sending request 510 to originating web server 504. Request 510 may be, for example, an HTTP request for content associated with a URI. In response to request 510, originating web server 504 may provide originating web content 512. Web browser 500 may, in response to receiving originating web content 512, display the originating web content on a display of the computing device, as illustrated by block 514.

Originating web content 512 from originating web server 504 may, in some instances, include a link (e.g., a URI) to target content (e.g., a website) of the target web service provided by target web server 502. In some instances, the link may include embedded therein an attribution tag indicating a manner or context in which the link was generated and shared by way of the originating web service.

At block 516, the link addressing the target content on target web server 502 may be selected (e.g., clicked) by way of a user interface of the computing device operating browser 500. In response to selection of the link, web browser 500 may provide to target web server 502 a request 518 for the target content addressed by a URI (e.g., Uniform Resource Locator (URL)) associated with the link. The attribution tag may be stored in the URI in the form of a CGI parameter and may thus be provided to target web server 502 along with the URI. Additionally, request 518 may include a referrer tag identifying the originating web server 504 (or an originating web service associated therewith) providing originating web content 512 from within which the link was selected. The referrer tag may be an HTTP header field containing a URI of the originating content on originating web server 504 from within which the link was selected. The referrer tag may be determined by browser 500 and may be included in request 518 by web browser 500.

Target web server 502 may, in response to receiving request 518, parse the request to extract therefrom any attribution tags or referrer tags, as indicated by block 520. In particular, target web server 502 may parse the URI addressing the requested target content to identify any attribution tags embedded in the URI. Similarly, target web server 502 may parse the HTTP header fields associated with request 518 to identify the referrer tag identifying the originating web service from within which the link was selected (e.g., the web service provided by originating web server 504).

Based on the attribution tag or the referrer tag, target web server 502 may determine whether a user navigated to the target content addressed by the link from a notification-like source or context. Example notification-like contexts are illustrated in and described with respect to FIGS. 4A and 4B. The attribution tag may indicate the context in which the link that includes the attribution tag was generated (i.e., the event that initiated the notification-like series of events) while the referrer tag may identify the context in which the link was selected to access the target content addressed thereby (i.e., the event that concludes the notification-like series of events).

Target web server 502 may determine whether the attribution tag or the referrer tag included in request 518 indicate that the user, if prompted to enable notifications from target web server 502, is likely to provide permission to target web server 502 to provide notifications (e.g., browser notifications). Target web server 502 may make such a determination by comparing the attribution tag or the referrer tag of request 518 against tag database 506 storing predefined attribution and referrer tags, as indicated at block 522.

The predefined attribution tags and referrer tags may be generated and stored in tag database 506 at a time prior to selection of the link at block 516, as indicated by block 508. In particular, tag database 506 may store, for each generated attribution tag, a descriptor of a corresponding event that caused the link to be generated and included within the content on originating web server 504. The attribution tag included in the link may be stored in tag database 506 prior to or concurrently with being included within the link. Similarly, tag database 506 may store a plurality of referrer tags that identify web services which are classified as notification-like sources. The plurality of referrer tags may be updated when, for example, additional web services begin providing notification-like content.

In particular, target web server 502 may reference the attribution tag from request 518 against tag database 506 to determine a trigger event that caused the link to be generated or included within the content provided by way of originating web server 504. Tag database 506 may store a descriptor identifying the trigger event corresponding to the attribution tag. The attribution tag from request 518 may indicate a notification-like context when the corresponding descriptor identifies a trigger event that has been classified as notification-like. Tag database 506 may further include a set of predefined referrer tags identifying web services classified as notification-like. The referrer tag from request 518 may indicate a notification-like context when the referrer tag is found within the set of predefined referrer tags.

The results of matching the attribution tag and the referrer tag against tag database 506 may be used separately or in combination to determine whether the content of target web service 502 is being accessed from a notification-like context. For example, target web service 502 may determine, based on the attribution tag, the referrer tag, and the comparison thereof against the tag database, a probability of receiving an affirmative response to a prompt requesting permission to provide the notifications. Accordingly, by referencing the attribution tag and/or the referrer tag against the tag database, target web service 502 may determine whether to prompt or re-prompt to request permission to provide notifications from target web service 502.

When the attribution tag and/or the referrer tag indicate a notification-like context, target web service 502 may provide instructions 526 to prompt, by web browser 500 or an operating system of a computing device executing web browser 500, for permission to display notifications from target web service associated with target web server 502. Target web server 502 may also provide the requested web content 524 to allow web browser 500 to display the target content addressed by the link.

In one example, the instructions 526 to prompt for permission to display notifications may comprise JavaScript included within the returned web content 524 and configured to cause web browser 500 to display a dialog prompt requesting permission to provide, by web browser 500, application-level notifications from the target web service.

In response to receiving target web content 524, web browser 500 may, at block 528, render and display the received target web content 524. Similarly, in response to receiving instructions 526 to prompt for notification permissions, web browser 500 may display a dialog prompt requesting permissions to display notifications from the target web service.

### VI. Example Operating System Implementation Control Flow

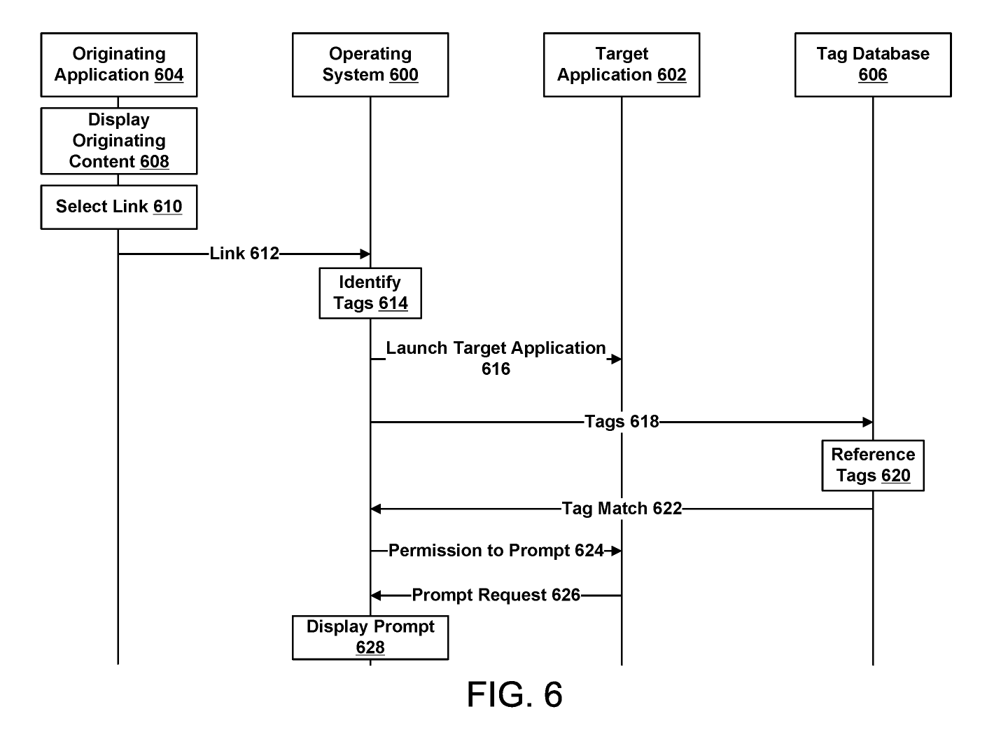

FIG. 6 includes an example message diagram illustrating operations that may be carried out to determine when to prompt, by an application on a computing device, for permission to display notifications from the application. The application may be associated with a corresponding web service and the notifications may thus be pushed to the application from the web service. The notifications may be operating system-level notifications provided by an operating system of the computing device on which the application is being executed. The operations illustrated in FIG. 6 may be carried out before prompting for permission for a first time or after a previous prompt for permission resulted in permission not being granted.

Notably, several of the operations described in connection with FIG. 6 parallel operations described in connection with FIG. 5. As such, variations of the operations described in connection with FIG. 5 are likewise applicable to the operations described in connection with FIG. 6. However, for the sake of brevity, these variations are not repeated.

In particular, originating application 604 may be used to access content provided by an originating web service. Target application 602 may be used to access content provided by a target web service. Operating system 600 may manage execution of the originating and target applications 604 and 602. Tag database 606 may store predefined attribution tags and referrer tags and may be communicatively connected to at least operating system 600.

At block 608, originating content may be displayed by originating application 604. The originating content may include a link to content associated with target application 602. In some instances, the link may include embedded therein an attribution tag indicating a manner or context in which the link was generated and shared by way of originating application 604.

At block 610, the link addressing content associated with target application 602 may be selected from within originating application 604. In response to selection of the link, originating application 604 may pass the link to operating system 600, as indicated by arrow 612. Operating system 600 may be configured to communicate with a corresponding server to acquire content addressed by the link.

At block 614, operating system 600 may identify the attribution tag by parsing the link. Operating system 600 may also determine the referrer tag by identifying originating application 604 or a deep-link to the content from within which the link was selected. Operating system 600 may further identify an application that will be used to display the received content. Operating system 600 may determine that target application 602 is configured to handle the link. This determination may be done using filters and handlers within operating system 600 or target application 602 that allow the selected link to be resolved into a deep-linked state within target application 602.

Operating system 600 may provide the identified tags to tag database 606, as indicated by arrow 618. Tag database 606 may be stored on a remote server device and may be accessible to operating system 600 by way of the Internet. Alternatively, Tag database 606 may be located on the computing device executing operating system 600. Tag database 606 may be periodically updated as new tags are generated. Tag database 606 may store, for each generated attribution tag, a descriptor of a corresponding event that caused the link to be generated and included within the content of originating application 604. Tag database 606 may also store a set of predefined referrer tags that have been classified as notification-like.

At block 620, the identified tags may be referenced against tag database 606. Any matches between the tags identified at block 614 and tags stored in database 606 may be returned to operating system 600, as illustrated by arrow 622. Based on the returned matches, operating system 600 may determine whether a user navigated to the content addressed by the link from a notification-like source or context.

When operating system 600 determines that the originating application 604 is a notification-like source (i.e., the link was accessed in a notification-like context), operating system 600 may indicate to target application 602 that target application 602 may prompt for permission to display notifications, as indicated by arrow 624. Notably, this may allow operating system 600 to permit applications to prompt for permission numerous times while also preventing the applications from overloading the user with notification requests.

In response, target application 602 may request that operating system 600 display a prompt requesting user permission to provide operating system-level notifications from target application 602. Accordingly, operating system, 600 may, at block 628, display the prompt requesting notification permission from a user.

In an alternative embodiment, the operations indicated by arrows 624 and 626 as well as block 628 may be modified to provide application-level control over the process of prompting for permission. In particular, the tag match returned according to arrow 622 may be passed from operating system 600 to target application 602. Target application 602 may determine, based on tag match 622, whether to prompt for notification permissions.

In a first example, target application 602 may determine whether to prompt for application-level notification permissions by way of an application-level prompt provided by target application 602. In another example, target application 602 may determine whether to prompt for operating system-level permission by way of an operating system-level prompt provided by operating system 600. This approach may be useful where operating system 600 limits the maximum number of times an application may prompt for operating system-level notification permissions. Thus, rather than prompting for permission at a predetermined and likely inopportune time, such as during application installation, target application 602 may instead prompt for notification permission when the context indicates that the user is likely to provide permission to receive notifications from target web service 602.

In an example implementation, target application 602 may be a music streaming application and originating application 604 may be a social media application. While browsing content from a social media service using social media application 604, a user may encounter a link to a song or music album available through a music streaming service. The link may have been posted to the social media service by another user to, for example, inform members of the social media service that the song or album is on sale.

The user may click the link within social media application 604. In response, operating system 600 may pause execution of social media application 604 and may begin executing music streaming application 602. Operating system 600 may communicate with a web server corresponding to the music streaming service to obtain content addressed by the link. Music streaming application 602 may be used to present the content (e.g., display album art and play songs). The attribution tag associated with the link and the referrer tag identifying social media application 604 may be used, as discussed above, to classify social media application 604 as a notification-like source. Social media application 604 may, under these circumstances, be classified as a notification-like source because it informed the user that the song or album is on sale.

Accordingly, in response to classifying social media application 604 as a notification-like source, music streaming application 602 may determine that now is an opportune time to request permission to provide the user with notifications. Thus, music streaming application 602 may display an application-level prompt for permission to provide in-app notifications to the user. Alternatively, music streaming application 602 may prompt operating system 600 to display a system-level prompt for permission to provide operating-system-level notifications to the user.

In some instances, the prompt may be for permission to receive notifications of a certain kind. For example, when the user click a link indicating availability of a new song, the permission may be to receive notifications informing the user of new content. When the user clicks a link indicating a reduced price of a song, the permission may be to receive notifications informing the user of sales currently going on.

### VII. Example Prompt for Notification Permission

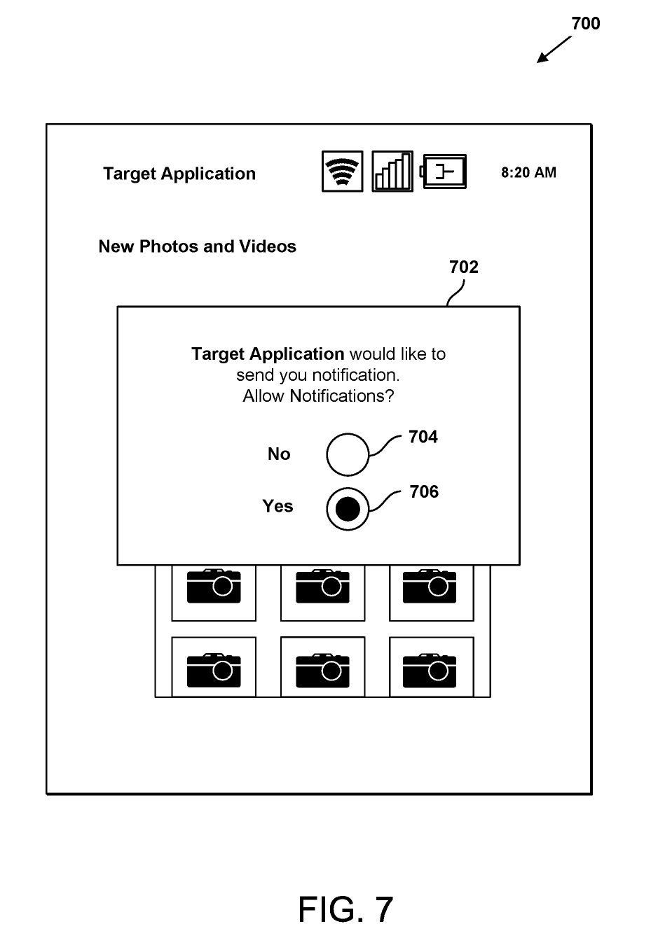

FIG. 7 illustrates an example graphical user interface (GUI) 700 that may be used with at least some embodiments described herein. In particular, GUI 700 is provided by a target application that is running on a computing device. As shown, the computing device displays, as a graphical element of the GUI 700, a permission request 702 that includes a dialog explaining that a target application would like to send notifications to the computing device. The notifications may be application-level notifications or operating system-level notifications. Permission request 702 may be overlaid atop the content requested from the target web server which, in this case, includes a listing of new photos and videos available from the target web server. The permission request 702 also includes a first selectable option 704 to deny access and a second selectable option 706 to allow access. Each of the selectable options is presented as a radio button, so that the user may only select one of the two options. As shown, the user has selected the first option to allow the target application to send the user notifications.

### VIII. Example Contextual Indicators

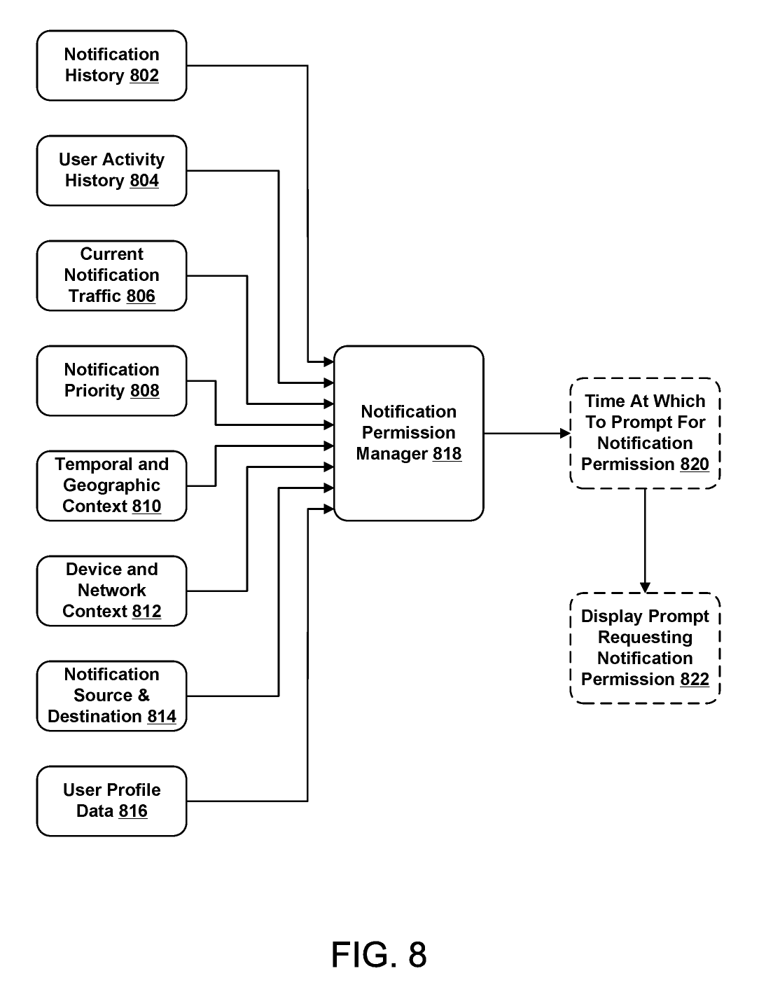

FIG. 8 illustrates example contextual indicators based on which a client device or web service may determine to prompt for permission to display notifications. In particular, FIG. 8 illustrates notification permission manager 818 configured to receive a plurality of contextual data associated with a particular client device or user thereof. The contextual data may generally represent a state of the client device, including parameters associated with the client device, at or near a particular point in time. The plurality of contextual data may include data representing notification history 802, user activity history 804, current notification traffic 806, notification priority 808, temporal and geographic context 812, notification source & destination 814, and user profile data 816, among other possibilities.

Notification permission manager 818 may be configured to determine, based on the plurality of contextual data, an opportune time at which to prompt for notification permission, as indicated at block 820. The contextual data may represent the state of the client device at or near this opportune time. The notification permissions may be permissions associated with a particular web service (e.g., target web service) or software application (e.g., target application). The prompt requesting notification permission may be displayed, for example, by way of the client device, as indicated by block 822.

Notification history 802 may include data representing notifications that a client device has received in the past as well as data representing user engagement with these notifications. Notification history 802 may include notifications from the past several minutes, hours, days, months, or years. Notification history 802 may be represented as a time series or as a notification frequency per unit time. Notification history 802 may include, for each of the notification received in the past, an identifier of a source of the notification (e.g., the web service that sent the notification), a type of the notification (e.g., news, advertisement, update, etc.), a priority level associated with the notification, an indication of whether the user engaged with the notification, as well as other contextual indicators discussed herein. Notification history 802 may indicate, for example, that a user engages more frequently with notifications from particular applications that, for example, provide content of a particular type.

User activity history 804 may include data representing tasks or activities that the user has engaged in during a prior time period. The tasks and activities may include software applications and web services that the user has engaged with during the prior time period. The prior time period may span the past several seconds, minutes, hours, days, or years. In one example, user activity history 804 may include data representing the originating web service or the originating application, as discussed with respect to FIGS. 5 and 6, respectively.

Current notification traffic 806 may include data representing, for example, notifications that are currently being pushed to the client device. Current notification traffic 806 may be represented as a frequency with which the client device is currently receiving notifications (e.g., 5 notifications received in the last 5 minutes). Current notification traffic 806 may also include data representing user engagement with the current notifications. For example, current notification traffic 806 may indicate that 10 notifications have been received by the client device in the past 3 minutes and that the user has engaged with 8 of the 10 notifications.

Notification priority 808 may include data representing a priority, importance, or urgency level associated with notifications. For example, an amber alert or a severe weather advisory alert may be assigned a higher priority level than a notification regarding products currently on sale from a particular retailer. Notification priority 808 may represent the priority level associated with notifications from the web service for which permissions are to be requested. Notification priority 808 may also represent priority levels associated with notifications represented by current notification traffic 806.

Temporal and geographic context 810 may include data representing the current time of day, day of the week, day of the year (e.g., holiday), planned events determined based on a user's calendar information, and current location. For example, a user may be more likely to provide permission to receive notification from a holiday gifts retailer around the holidays. Similarly, a user may be more likely to provide permission to receive notifications from a retailer regarding ongoing sales when the user is currently at the mall.

Device and network context 812 may include data representing a device type or form factor (e.g., watch, phone, tablet, laptop, desktop) as well as current network connectivity or bandwidth utilized by the client device.

Notification source and destination 814 may include data representing the web service requesting permission to provide notifications on the client device (e.g., the target web service). The notification destination may include a software application (e.g., the target application) on the client device associated with the web service requesting permission. In one example, user activity history 804 may be used to determine a high level of user engagement with the software application associated with the web service requesting notification permission. This may indicate that, due to the high level of user engagement, the user is likely to provide permission to display notifications.

User profile 816 data may represent a user ID, a user type, or user age, among other user-specific identifiers. In one example, user age may be used to determine whether to prompt for notification permissions based on the content offered by a particular web service (e.g., determine whether the user is old enough to view content). The user may have complete control over what information is included in user profile 816 and/or what information in user profile 816 is made available to notification permission manager 818. Further, the user may generally have privacy control over any information associated with the user or the client device. Thus, the user may choose to opt-out of sharing any of the data herein discussed.

In some implementations, notification permission manager 818 may be implemented as software instructions. Alternatively, notification permission manager 818 may be implemented as purpose-built hardware. Notification permission manager 818 may be implemented as part of a client device (e.g., as part of an application of the client device or as part of an operating system of the client device) or a server device (e.g., a cloud server device). The server device may be, for example, a server device associated with the web service requesting the notification permission. In some embodiments, notification manager 818 may be further configured to perform the operations described with respect to FIGS. 3, 4A, 4B, 5, and 6.

In some implementations, notification permission manager 818 may be implemented as a set of predetermined rules. The rules may include thresholds, ranges, and combinations of the contextual data 802-816 that indicate opportune times at which to prompt for notification permissions. One example rule might indicate an opportune time to prompt for notification permission when (i) user activity history 804 indicates a high frequency of engagement by the user with the web service seeking notification permissions and (ii) current notification traffic 806 indicates that the user is currently engaging with notifications. Other rules are possible and might involve some or all of the contextual data 802-816.

In other implementations, notification permission manager 818 may be implemented using one or more machine learning algorithms. In one example, notification permission manager 818 may be implemented as an artificial neural network (ANN). The ANN may include a plurality of input nodes, a plurality of hidden nodes connected to the input nodes, and an output node connected to the hidden nodes. The input nodes may be connected to the contextual data 802-816. The hidden nodes may be configured to process the contextual data 802-816 to determine an opportune time at which to prompt for notification permission. The output of the ANN (and of notification permission manager 818 generally) may be a binary “yes/no” response. The binary response might indicate whether now is an opportune time to prompt for notification permission. Alternatively, the output of the ANN (and of notification permission manager 818 generally) may be a time value indicating at least one future time identified as an opportune time to prompt for notification permission. Other machine learning algorithms may be used as well or instead, including decision tree learning, Support Vector Machine (SVM), and Bayesian Networks, among other possibilities.

### IX. Additional Example Operations

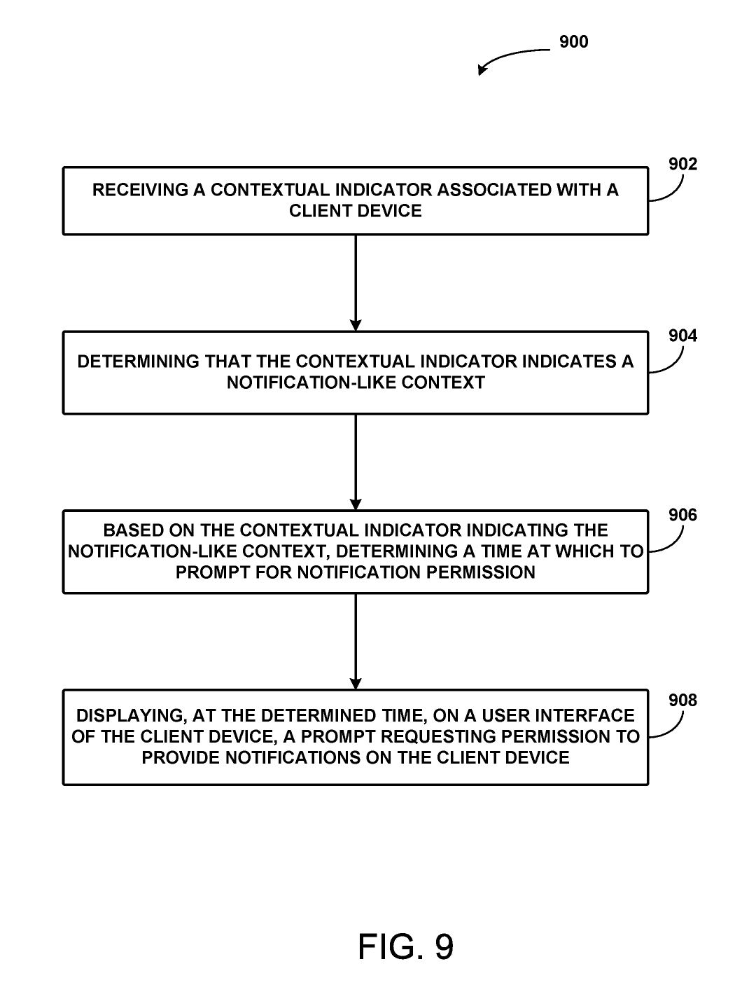

FIG. 9 is a flow chart 900 illustrating example operations. The embodiment illustrated by FIG. 9 may be carried out by a computing device, such as computing device 200. However, the embodiment can also be carried out by other types of devices or device subsystems. For example, the embodiment may be carried out by a server device (e.g., the target web server device) communicatively connected to computing device 200 from which computing device 200 may request web content. Further, the embodiment may be combined, in part or in whole, and may incorporate any aspect or feature disclosed in this specification or the accompanying drawings.

At block 902, a contextual indicator associated with a client device may be received. In one example, the contextual indicator may include one or more of the contextual indicators 802-816 described with respect to FIG. 8. In some embodiments, the contextual indicator may additionally or instead include the attribution tag or the referrer tag described with respect to FIGS. 3, 4A, 4B, 5, and 6. The contextual indicator may be received by, for example, notification permission manager 818 implemented as part of an application on the client device, an operating system of the client device, or a remote cloud server device (e.g., a server device associated with a web service seeking notification permission).

At block 904, it may be determined that the contextual indicator indicates a notification-like context. That is, the contextual indicator signals that a user of the client device, if prompted for notification permission from an app or web service, is likely to provide permission. The contextual indicator may indicate that the user is currently engaging in a behavior or exhibiting a behavior pattern suggesting that the user is likely interested in receiving notifications and will thus respond in the affirmative to a request for notification permission.

In block 906, a time at which to prompt for notification permission may be determined based on the contextual indicator indicating the notification-like context. In some embodiments, the determination may indicate that now is a good time to prompt for notification permission (i.e., the user is currently engaging with the client device in a manner that suggests that the user is likely to provide notification permission). Alternatively, the determination may indicate a future time at which to prompt for notification permission or a future condition that will trigger a prompt for notification permission. For example, it may be determined that the user has engaged with a particular application or web service for at least a predetermined length of time. The opportune time may be determined as the next time the user opens the application.

In block 908, a prompt requesting permission to provide notifications on the client device may be displayed on a user interface of the client device at the determined time. The prompt may be similar to the prompt illustrated in FIG. 7. The prompt may be displayed at the determined time, rather than another, less-opportune time, to increase the likelihood of the user providing notification permission. Thus, the operations of flow diagram 900 may avoid the drawbacks of a user not providing notification permission when the user is asked at the less opportune time.

In some embodiments, the operations and embodiments disclosed herein may also be used to determine when to display notifications from applications or web services which have been granted notification permission. Thus, rather than displaying notifications when they are generated and sent by the web service or application, the notifications may be displayed at contextually-opportune times when the user of the client device is more likely to engage with the notifications. The criteria for identifying an opportune time at which to provide a notification may be similar to the criteria for identifying an opportune time at which to request notification permission. In some embodiments, the criteria may be modified.

### X. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages can be executed out of order from that shown or discussed, including substantially concurrent or in reverse order, depending on the functionality involved. Further, more or fewer blocks and/or functions can be used with any of the ladder diagrams, scenarios, and flow charts discussed herein, and these ladder diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A method comprising:
receiving, from an application of a client device by a target web server device, a request for target content associated with the target web server device, wherein the request was generated based on originating content provided by an originating web server device, and wherein the reception of the request causes the target web server device to transmit, to the application, data corresponding to the request;
identifying, by the target web server device, (i) a referrer tag in the request that identifies an originating web service associated with the originating web server device or (ii) an attribution tag in the request that identifies a trigger event that caused the attribution tag to be included within the originating content;
determining, by the target web server device, that the referrer tag or the attribution tag is in a set of predefined tags that classifies the originating web service as a notification-like source; and
in response to determining that the referrer tag or the attribution tag is in the set of predefined tags, transmitting, by the target web server device, instructions to the application, wherein reception of the instructions causes the client device to display, on a user interface of the client device, a prompt requesting permission to provide, on the client device, notifications from a target web service associated with the target web server device.

2. The method of claim 1, further comprising:
in response to displaying the prompt, receiving input data representing authorization to provide, on the client device, the notifications from the target web service; and
based on receiving the input data representing the authorization, transmitting to the client device a notification from the target web service.

3. The method of claim 1, wherein identifying the attribution tag comprises:
parsing a Uniform Resource Identifier (URI) associated with the request to identify a parameter within the URI that represents the attribution tag.

4. The method of claim 1, wherein determining that the attribution tag is in the set of predefined tags comprises:
referencing the attribution tag against a database storing the set of predefined tags to identify the trigger event that caused the attribution tag to be included in a URI included in the originating content, wherein the set of predefined tags includes predefined attribution tags, and wherein each respective attribution tag of the predefined attribution tags is associated with a corresponding trigger event that causes the respective attribution tag to be included within a corresponding URI; and
determining, based on referencing the attribution tag against the database, that the target web service caused the attribution tag to be included in the URI included in the originating content in order to inform the client device of the target content available from the target web service and addressed by the URI.

5. The method of claim 1, wherein determining that the attribution tag is in the set of predefined tags comprises:
referencing the attribution tag against a database storing the set of predefined tags to identify the trigger event that caused the attribution tag to be included in a URI included in the originating content, wherein the set of predefined tags includes predefined attribution tags, and wherein each respective attribution tag of the predefined attribution tags is associated with a corresponding trigger event that causes the respective attribution tag to be included within a corresponding URI; and
determining, based on referencing the attribution tag against the database, that the URI included in the originating content was shared by a creator of content available from the target web service.

6. The method of claim 1, wherein determining that the attribution tag is in the set of predefined tags comprises:
referencing the attribution tag against a database storing the set of predefined tags to identify the trigger event that caused the attribution tag to be included in a URI included in the originating content, wherein the set of predefined tags includes predefined attribution tags, and wherein each respective attribution tag of the predefined attribution tags is associated with a corresponding trigger event that causes the respective attribution tag to be included within a corresponding URI; and
determining, based on referencing the attribution tag against the database, that the URI included in the originating content was shared by a member of a social network to which a user associated with the client device belongs.

7. The method of claim 1, wherein identifying the referrer tag comprises:
parsing the request to identify, within the request, a parameter representing the referrer tag.

8. The method of claim 1, wherein determining that the referrer tag is in the set of predefined tags comprises:
determining that the referrer tag identifying the originating web service is in a set of predefined referrer tags, wherein each respective referrer tag of the set of predefined referrer tags identifies a web service classified as a notification-like source and configured to provide information of new content available from the target web service.

9. The method of claim 1, further comprising:
determining that the target content is content of a first type, wherein the target web service also provides content of a second type different from the first type; and
based on determining that the target content is content of the first type, providing the instructions to the application, wherein reception of the instructions causes the client device to display, on the user interface of the client device, the prompt requesting permission to provide notifications of content of the first type from the target web service.

10. The method of claim 1, wherein the application on the client device is an originating application configured to display content provided by the originating web service, and wherein reception of the data corresponding to the request causes the client device to initiate execution of a target application configured to display representations of the data corresponding to the request.

11. The method of claim 1, wherein the notifications are operating-system-level notifications provided by an operating system of the client device in response to the target web service transmitting the notification to the client device.

12. The method of claim 1, wherein the notifications are application-level notifications provided by a target application on the client device in response to the target web service transmitting the notifications to the client device.

13. The method of claim 12, wherein the target application is a web browser, wherein the target web service is associated with a first web domain, and wherein the originating web service is associated with a second web domain.

14. A method comprising:
receiving, from an originating application on a computing device, by the computing device, a selection of a link to target content associated with a target application on the computing device, wherein the link is selected from within originating content provided by the originating application, and wherein the selection of the link causes an operating system of the computing device to initiate execution of the target application;
identifying, by the computing device, (i) a referrer tag identifying the originating application or (ii) an attribution tag associated with the link and identifying a trigger event that caused the link to be included within the originating content;
determining, by the computing device, that the referrer tag or the attribution tag is in a set of predefined tags that classifies the originating application as a notification-like source; and
in response to determining that the referrer tag or the attribution tag is in the set of predefined tags, displaying, on a user interface of the computing device, a prompt requesting permission to provide, on the computing device, notifications from the target application.

15. The method of claim 14, further comprising:
determining that the target application has not been granted permission to provide notifications on the computing device; and
based on determining that the target application has not been granted permission to provide notifications on the computing device, displaying the prompt.

16. The method of claim 14, wherein identifying the referrer tag comprises:
determining, by an operating system of the computing device, the originating application from which the selection of the link is received.

17. The method of claim 14, wherein the notifications are application-level notifications provided by the target application while the computing device is executing the target application.

18. The method of claim 14, wherein the notifications are operating-system-level notifications provided by an operating system of the computing device in response to requests from the target application, wherein a setting of the operating system indicates that the target application has not been granted permission to provide notifications, and wherein the operating system is configured to allow the target application to request permission to provide the operating system-level notifications a threshold number of times, the method further comprising:
determining, by the operating system, that the target application has requested permission to provide the operating-system-level notifications less than the threshold number of times; and
based on determining that the target application has requested permission to provide the operating-system-level notifications less than the threshold number of times, displaying the prompt.

19. The method of claim 14, wherein the notifications are operating-system-level notifications provided by an operating system of the computing device in response to requests from the target application, wherein a setting of the operating system indicates that the target application has not been granted permission to provide notifications, and wherein the operating system is configured to allow the target application to request permission to provide the operating-system-level notifications less than a threshold number of times, the method further comprising:
determining, by the operating system, that the target application has requested permission to provide the operating-system-level notifications at least the threshold number of times; and
based on determining that the target application has requested permission to provide the operating-system-level notifications at least the threshold number of times, displaying the prompt.

20. A non-transitory computer-readable medium having stored thereon instructions that, when executed by a target web server device, cause the target web server device to perform operations comprising:
receiving, from an application of a client device, a request for target content associated with the target web server device, wherein the request was generated based on originating content provided by an originating web server device, and wherein the reception of the request causes the target web server device to transmit, to the application, data corresponding to the request;
identifying (i) a referrer tag in the request that identifies an originating web service associated with the originating web server device or (ii) an attribution tag in the request that identifies a trigger event that caused the attribution tag to be included within the originating content;
determining that the referrer tag or the attribution tag is in a set of predefined tags that classifies the originating web service as a notification-like source; and
in response to determining that the referrer tag or the attribution tag is in the set of predefined tags, transmitting instructions to the application, wherein reception of the instructions causes the client device to display, on a user interface of the client device, a prompt requesting permission to provide, on the client device, notifications from a target web service associated with the target web server device.
